(19) United States
(12) Patent Application Publication
(10) Pub. No.: US 2026/0010762 A1
(43) Pub. Date: Jan. 8, 2026

(54) DYNAMIC INTENT-BASED LLM ARBITRATION

(71) Applicant: SoundHound AI IP, LLC, Santa Clara, CA (US)

(72) Inventor: Keyvan Mohajer, Atherton, CA (US)

(73) Assignee: SoundHound AI IP, LLC, Santa Clara, CA (US)

(21) Appl. No.: 18/765,871

(22) Filed: Jul. 8, 2024

(51) Int. Cl. G06N 3/0455

(52) U.S. Cl. CPC G06N 3/0455

(57) ABSTRACT

Systems and methods are provided for processing prompts to a large language model based on a corresponding intent of a received prompt. The systems and methods select, based on determined corresponding intents, from a plurality of information resource engines to process the received prompts.

### FIELD

The present technology relates to interaction with a large language model, and in particular to a system and method of dynamic user intent-based processing of user prompts to a large language model.

### BACKGROUND

Lage language models (LLMs) have great potential to advance human interaction with voice and digital assistants. These models employ artificial intelligence to understand language and generate natural, human-like responses to queries to provide rich conversational interactions. But LLMs also have some significant limitations.

In particular, LLMs can be very slow to respond to user inputs (referred to herein as “user prompts”), may provide outdated information, or may respond that the LLM is unable to provide information on the subject of particular user prompts (also referred to herein as “knowledge gaps”). In addition, LLMs sometimes “hallucinate,” providing responses that are factually incorrect or non-sensical.

In addition, LLMs can be very expensive to use. Tokens represent the fundamental units used to measure an amount of text processed by an LLM. When a user prompt is sent to an LLM (e.g., via an LLM API), the LLM API typically divides the prompt into tokens for analysis and response generation. A token refers to a basic unit of text that the model processes, typically individual words or punctuation marks. The cost associated with using an LLM API is typically based on the number of tokens consumed per request. As a result, hallucinations, outdated responses, and knowledge gaps in an LLM can quickly become very expensive but ultimately useless information.

### DESCRIPTION OF THE DRAWINGS

FIG. 1A is a schematic block diagram of an embodiment of a prompt processing system according to embodiments of the present technology.

FIG. 1B is an illustration of various types of prompt comprising system prompts and responses according to embodiments of the present technology.

FIG. 1C is an illustration of various types of prompt comprising system prompts according to embodiments of the present technology.

FIGS. 2A-2B together depict a flowchart showing operation of an example intent-based processing of user prompts by a prompt processing server according to embodiments of the present technology.

FIG. 2C1 depicts example components of first and second LLM prompts according to embodiments of the present technology.

FIG. 2C2 depicts an example system prompt and an example user prompt according to embodiments of the present technology.

FIG. 2C3 depicts example LLM processing of first and second LLM prompts according to embodiments of the present technology.

FIG. 2D is a flowchart showing the operation flowchart showing the operation of an example intent-based selection of information resource engines by a prompt processing server according to embodiments of the present technology.

FIG. 2E diagram depicting an example database of predetermined intents, associated information resource engines, and corresponding information resource engine identifiers according to embodiments of the present technology.

FIG. 2F depicts example processing by an example content domain of an LLM prompt and generation of an example response according to embodiments of the present technology.

FIG. 2G depicts another example processing by an example content domain of an LLM prompt and generation of an example response according to embodiments of the present technology.

FIG. 3 is a flowchart showing operation of parallel processing of prompts according to embodiments of the present technology.

FIG. 4 is a generic illustration of a prompt broken into token groups according to embodiments of the present technology.

FIG. 5 is an illustrative example of a prompt broken into token groups according to embodiments of the present technology.

FIG. 6 is a generic illustration of a prompt broken into token groups according to further embodiments of the present technology.

FIG. 7 is an illustrative example of a prompt broken into token groups according to further embodiments of the present technology.

FIG. 8 is a generic illustration of a prompt broken into token groups according to further embodiments of the present technology.

FIGS. 9-10 comprise a flowchart showing the operation of nested loop processing of prompts according to embodiments of the present technology.

FIG. 11 is a schematic block diagram of a computing environment according to embodiments of the present technology.

### DETAILED DESCRIPTION

The present technology will now be described with reference to the figures, which in general relate to systems and methods for processing prompts to an LLM based on one or more corresponding intents of a received prompt. The systems and methods select, based on determined corresponding intents, from a plurality of information resource engines to process the received prompts.

The plurality of information resource engines include information resource engines that are configured to provide information regarding specific subject matter. For example, a first information resource engine may be configured to provide information regarding weather, a second information resource engine may be configured to provide information regarding stock prices, a third information resource engine may be configured to provide information regarding a particular car brand. In many instances, the information resource engines are better able to process prompts regarding their specific subject matter than an LLM engine.

Thus, the present technology selects, based on determined corresponding intents, from a plurality of information resource engines to process received prompts. For example, if a prompt has a corresponding intent “weather,” the present technology selects an information resource engine that is configured to provide weather information to process and provide a response to the prompt. Similarly, if a prompt has a corresponding intent “fashion,” the present technology selects an information resource engine that is configured to provide fashion information to process and provide a response to the prompt. If, however, a prompt has a corresponding intent “general subject matter,” the present technology selects the LLM response to the prompt. Without wanting to be bound by any particular theory, it is believed that the present technology may improve the quality of replies to LLM prompts.

The present technology in general also relates to systems and methods for processing token groups input to an LLM in parallel and/or by nested processing. Each token group may include one or more tokens from a system prompt and user prompt. In addition to simple parallel processing of the one or more token groups, prompts may be input as nested prompts, where processing of one or more token groups may be begin and end at different times, depending on satisfaction of a start and/or end condition.

One or more of the token groups may have dynamic values which change based on the state of earlier searched token groups. Analysis of the one or more token groups may proceed deterministically, start to finish, to obtain the final results. Alternatively, using nested searches and dynamic prompts, analysis of token groups may be recursive, with a single token group analyzed two or more times with different state values.

It is understood that the present technology may be embodied in many different forms and should not be construed as being limited to the embodiments set forth herein. Rather, these embodiments are provided so that this disclosure will be thorough and complete and will fully convey the technology to those skilled in the art.

Indeed, the described technology is intended to cover alternatives, modifications and equivalents of these embodiments, which are included within the scope and spirit of the technology as defined by the appended claims. Furthermore, in the following detailed description, numerous specific details are set forth to provide a thorough understanding of the described technology. However, it will be clear to those of ordinary skill in the art that the disclosed technology may be practiced without such specific details.

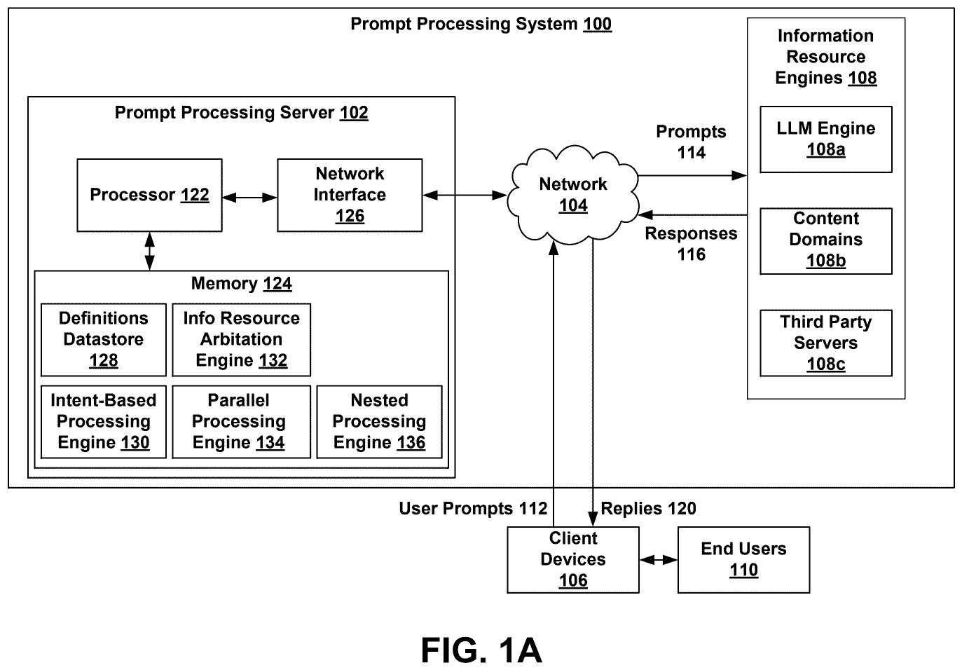

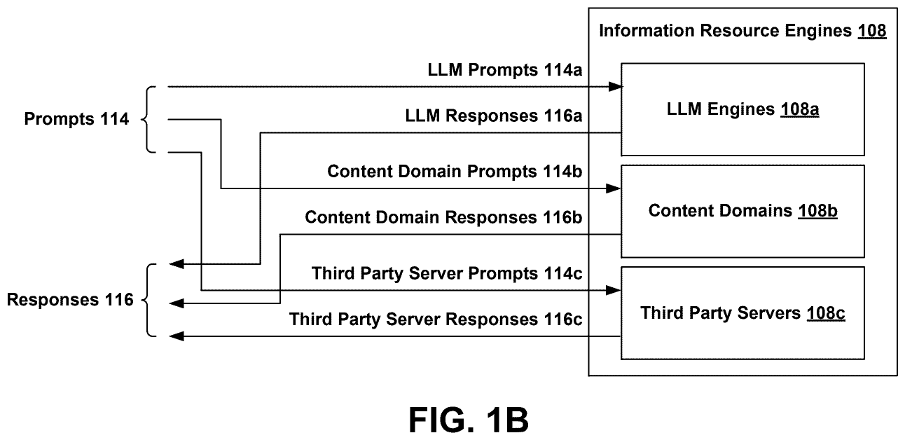

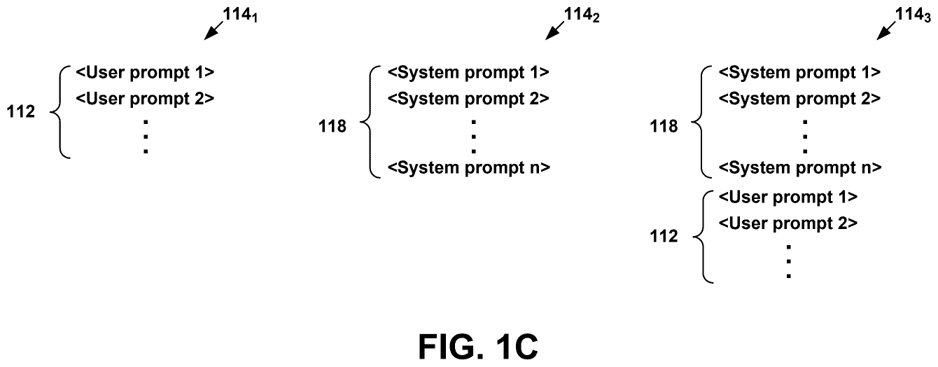

FIG. 1A is a schematic block diagram of an embodiment of a prompt processing system 100 that includes a prompt processing server 102 that is coupled via a network 104 to client devices 106 and information resource engines 108. In other embodiments, prompt processing architecture 100 may include more, fewer or different components.

In embodiments, prompt processing server 102 may be included in a service provider platform, such as a service provider platform that provides end users 110 of client devices 106 with voice recognition and verbal and textual interaction services. Other types of service provider platforms also may be used.

In embodiments, network 104 may be one or more of a local area network, a wide area network, a private network, the Internet, a wired network, a wireless network, a satellite network, or other similar network.

In embodiments, client devices 106 may include mobile phones, smart watches, desktop computers, laptop computers, smart speakers (e.g., Alexa, Google Home, Nest, Home Pod), smart TVs, smart car interfaces, smart home interfaces, voice assistants and other similar client devices.

In embodiments, information resource engines 108 may include one or more information service engines, such one or more LLM engines 108a, one or more content domains 108b, and one or more third party servers 108c, or other similar information service engines. Persons of ordinary skill in the art will understand that information resource engines 108 may include additional, fewer, or different information services.

In embodiments, some or all information resource engines 108 may be included in prompt processing server 102. For example, prompt processing server 102 may include content domains 108b, but all other information resource engines 108 may be separate from prompt processing server 102. Alternatively, prompt processing server 102 may include LLM engine 108, but all other information resource engines 108 may be separate from prompt processing server 102. Other configurations also are possible.

In an embodiment, prompt processing server 102 may be physically located at a single service provider facility, or may include one or more servers distributed over multiple locations. Prompt processing server 102 may be operated by a single entity (e.g., an individual, a business, a university, a government) or may be jointly operated by multiple entities.

In embodiments, prompt processing server 102 receives requests for information or actions (referred to herein as “user prompts 112”) from end users 110 who communicate user prompts 112 to prompt processing server 102 via client devices 106 and network 104.

In embodiments, user prompts 112 may include questions (e.g., “What is the circumference of Mars?”), requests (e.g., “Please provide a brief summary of “War and Peace.”), statements (e.g., “I don't know where to go on vacation!”), automation commands (e.g., “Unlock the car.”), and other similar types of user prompts. Persons of ordinary skill in the art will understand that these are some examples of user prompts 112, which may be classified using additional and/or different categories.

In embodiments, end users 110 may generate user prompts 112 on client devices 106 verbally (e.g., by speaking into a microphone on client devices 106), textually (e.g., by typing on a keyboard, keypad, or other text input device on client devices 106), or by other means or a combination of such means.

In embodiments, prompt processing server 102 provides instructions or queries (referred to herein as “Prompts 114”) to information resource engines 108 for processing. In an embodiment, information resource engines 108 process the received Prompts 114 and provide corresponding Responses 116 to prompt processing server 102.

As described in more detail below, a Prompt 114 may include one or more user prompts 112 and one or more system prompts 118. In an embodiment, after receiving a user prompt 112, prompt processing server 102 provides LLM engine 108a with a Prompt 114 that includes the received user prompt 112 and a system prompt 118 (e.g., <intent>). In an embodiment, the system prompt 118 (<intent>) requests that LLM engine 108a determine one or more corresponding intents of the user prompt 112.

In embodiments, intents generally describe a subject matter of user prompt 112. For example, a first user prompt 112 (“Is it going to be hot today in Phoenix?”) may have a corresponding intent (<intent: weather>), a second user prompt 112 (“How many seconds are there in a year?”) may have a corresponding intent (<intent: general knowledge>), a third user prompt 112 (“What should I make for dinner with chicken breasts?”) may have a corresponding intent (<intent: recipes>), and so on.

In embodiments, user prompt 112 may have more than one corresponding intent. For example, a user prompt 112 (“What are the best European vacation locations in July where the weather is not too hot, and there are good bargains on clothes?”) may have three corresponding intents (<intent: travel, weather, shopping>). Thus, in an embodiment, in response to a system prompt 118 (e.g., <intent>) that requests that LLM engine 108a determine a corresponding intent of the included user prompt 112, LLM engine 108a may return multiple corresponding intents.

For simplicity, unless otherwise stated the following description will refer to a single corresponding intent for each user prompt 112. Persons of ordinary skill in the art will understand that the described technology also may be used with user prompts 112 that have multiple corresponding intents.

In an embodiment, upon receiving a Prompt 114 that includes the received user prompt 112 and system prompt 118 (e.g., <intent>), LLM engine 108a determines the corresponding intent of the included user prompt 112. In an embodiment, LLM engine 108a returns a Response 116 that includes the determined corresponding intent to prompt processing server 102.

In an embodiment, based on the determined intent from LLM engine 108a, prompt processing server 102 is configured to select (or “arbitrate”) one or more information resource engines 108 to formulate a corresponding Response 116 to the received user prompt, and then provide the received Response 116 as a reply 120 to an end user 110 via network 104 and client devices 106.

In embodiments, Prompts 114 may have a unique format and/or content corresponding to requirements of the information resource engine 108 that receives the Prompt 114. For example, as depicted in FIG. 1B Prompts 114 may include LLM prompts 114a, content domain prompts 114b and third party server prompts 114c. In embodiments, LLM prompts 114a, content domain prompts 114b, and third party server prompts 114c may have a same format and include same information, or may have different formats and include different information unique to the corresponding requirements of the information resource engine 108.

In embodiments, Responses 116 provided by information resource engines 108 may have a unique format or content corresponding to specifications of the information resource engine 108 that provides the Response 116. For example, as depicted in FIG. 1B Responses 116 may include LLM responses 116a, content domain responses 116b, and third party server responses 116c. In embodiments, LLM responses 116a, content domain responses 116b, and third party server responses 116c may have a same format, or may have different formats unique to the corresponding specifications of the information resource engine 108.

FIG. 1C depicts three example Prompts 114. A first example Prompt 114₁ includes one or more user prompts 112, a second example Prompt 114₂ includes one or more system prompts 118, and a third example Prompt 114₂ includes one or more user prompts 112 and one or more system prompts 118.

In embodiments, system prompts 118 may request specific information from an information resource engine 108 (e.g., LLM engine 108a) regarding a user prompt 112. As described above, one type of system prompt 118 (e.g., <intent>) requests that an LLM engine 108a determine a corresponding intent of a user prompt 112 included with the system prompt 118.

In other embodiments, system prompts 118 may instruct or train an information resource engine 108 on what type of Response 116 to generate for certain types of Prompts 114. For example, system prompts 118 may be used to train LLM engine 108a on how to determine corresponding intents for user prompts 112. In particular, system prompts 118 may include sample user prompts 112 with corresponding intents identified for the sample user prompts 112, and in this way train LLM engine 108a on intent determination. Other types of system prompts 118 also may be used.

Referring again to FIG. 1A, in an embodiment prompt processing server 102 includes a processor 122, a memory 124 and a network interface 126. Persons or ordinary skill in the art will understand that prompt processing server 102 may include additional or other components than those depicted in FIG. 1A.

In an embodiment, processor 122 is configured to control operation of prompt processing server 102, and facilitate communication between various components of prompt processing server 102. In an embodiment, processor 122 may be a standardized processor, a specialized processor, a microprocessor, a graphics processing unit, or the like that may execute instructions for controlling prompt processing server 102.

In an embodiment, memory 124 stores one or more algorithms that may be executed by processor 122. In an embodiment, memory 124 may include one or more of RAM, ROM, cache, flash memory, a hard disk, a solid state drive, and/or any other suitable storage component. In an embodiment, all or part of memory 124 may be integrated into processor 122 or separate from processor 122. In an embodiment, memory 124 stores various data stores and/or software application programs executed by processor 122 for controlling operation of prompt processing server 102.

One such datastore from implementing aspects of the present technology includes a definitions datastore 128. Examples of the software application programs for implementing aspects of the present technology include an intent-based processing engine 130, an information resource arbitration engine 132, a parallel processing engine 134 and a nested processing engine 136. These datastores and software application programs are explained in greater detail below.

In embodiments, network interface 126 includes software and/or hardware circuits for connecting processor 122 to network 104. For example, network interface 126 may include one or more of an ethernet interface, a WiFi adapter, a mobile network interface, or other similar network interface.

In embodiments LLM engine 108a is a computational system or platform that hosts and operates a large language model. Examples of LLM engine 108a include OpenAI GPT-4, Gemini 1.5 LLM, PaLM2, Meta LLAMA 2, GooseAI, Anthropic Claude 2, Cohere, and other similar LLM engines. In some embodiments, prompt processing server 102 may be coupled via network 104 to multiple LLM engines 108a.

In embodiments, LLM engine 108a is designed to handle complex algorithms and computations required for natural language processing tasks, and typically provides an API through which developers can send audio and/or text inputs and receive audio and/or text responses generated by the LLM. In embodiments, all or part of LLM engine 108a may be integrated into processor 122 of prompt processing server 102.

In embodiments, LLM engine 108a is configured to receive an input (e.g., an LLM prompt 114a), and use models and algorithms to generate an output that responds to the prompt and includes new, original content based on a given dataset on which the LLM has been trained. LLM models are trained on extensive datasets and possess the ability to generate coherent and contextually relevant text based on provided input.

In one example, LLM engine 108a may be trained and developed by the following steps.

Data Collection and Preprocessing: LLM engine 108a may be provided with a diverse and extensive data set including a wide range of text from various sources, such as books, articles, websites, and more. The data may be pre-processed to ensure consistency, remove noise, and normalize the input format. The text may be broken down into smaller units, often words or sub-words. Each unit may be assigned a unique identifier or token.

Model Architecture Selection: LLM engine 108a may be configured in a variety of different model architectures, such as a transformer architecture, a generative adversarial network (GAN), a variational autoencoder (VAE), an autoregressive model, or other types of models designed for generative tasks. For large language models like GPT, a transformer architecture which utilizes self-attention mechanisms often is used. Self-attention mechanisms enable the model to weigh the importance of different words in a sequence when processing each word, allowing the model to capture relationships and dependencies between words more effectively.

Training the Model: LLM engine 108a may then be trained using the prepared dataset. During training, the dataset may be divided into training, validation, and test sets. A training set is used to update the model parameters, a validation set is used to fine-tune hyperparameters and prevent overfitting, and a test set evaluates the model's generalization to unseen data. Using an optimization algorithm (e.g., stochastic gradient descent) the model parameters are iteratively updated based on the training data. The model is regularly evaluated based on the validation dataset to monitor its performance. The test set is used to assess the final performance and generalization of the model.

Persons ordinary skill in the art will understand that the above steps for developing and training LLM engine 108a are only examples, and that additional and/or alternative steps may be used to develop and/or train LLM engine 108a for use with the present technology.

In embodiments, content domains 108b may include programs that allow prompt processing server 102 to respond to user prompts 112 regarding specific subject matter. In embodiment, each content domain 108b is configured to provide information regarding a corresponding subject matter. Example subject matters include weather, restaurants, sports, podcasts, audiobooks, hiking trails, fitness, recipes, music, horoscopes, parking, traffic, movies, stocks and other similar topics.

In embodiments, content domains 108b may be public, private and/or customizable. In embodiments, content domains 108b may retrieve responses to user prompts 112 from one or more third party servers 108c, or may retrieve responses to user prompts 112 from content servers included in or hosted by prompt processing server 102.

In embodiments, third party servers 108c may include systems or services that gather and store information about corresponding subject matter, and provide access to such information to developers, typically via an API. For example, one type of third party server 108c may be a weather server that gathers real-time or forecasted weather data from various sources (such as meteorological agencies or weather APIs), and provides current weather conditions, weather forecasts, and weather alerts.

Another type of third party server 108c may be a flight tracking server that gathers real-time or scheduled flight information, such as flight statuses, schedules, and routes. Still another example of a third party server 108c may be a sports server that gathers and provides sports scores, schedules, player statistics, and other sports-related data. Persons of ordinary skill in the art will understand that these are just a few examples of types of third party servers 108c that may be included in information resource engines 108.

As described above, based on the determined corresponding intent from LLM engine 108a, prompt processing server 102 is configured to select an information resource engine 108 to provide a Response 116 to the received user prompt 112, receive the Response 116 from the selected information resource engine 108, and then provide the received Response 116 as a reply 120 to an end user 110 via network 104 and client devices 106.

For example, LLM engine 108a may determine that a first user prompt 112 (“Is it going to be hot today in Phoenix?”) has a corresponding intent (<intent: weather>). LLMs generally cannot provide current or forecast weather information, and may only provide very general information about weather in a particular city or region.

In embodiments, content domains 108b may include a weather content domain that is suited for providing current and forecast weather information. Thus, in such a scenario prompt processing server 102 may select the weather content domain to process the first user prompt 112 to provide a Response 116 instead of using a Response 116 from LLM engine 108a to the first user prompt 112.

In contrast, LLM engine 108a may determine that a second user prompt 112 (“How many seconds are there in a year?”) has a corresponding intent (<intent: general knowledge>). LLMs are generally excellent at providing answers about general knowledge. In such a scenario, prompt processing server 102 may select LLM engine 108a reply to the second user prompt 112, and not route the second user prompt 112 to other information resource engines 108.

In another example, prompt processing server 102 may select between multiple LLMs. For example, LLM engine 108a may determine that a third user prompt 112 (“Explain the theory of relativity.”) has corresponding intents (<intent: general knowledge, physics>). Information resource engines 108 may not include a content domain 108b or third party server 108c specifically tailored to answering questions about physics.

However, information resource engines 108 may include multiple LLM engines 108a, one of which (e.g., LLM engine 108a₁) is better at answering science-related general knowledge questions. In such a scenario, prompt processing server 102 may select LLM engine 108a₁ to process the first user prompt 112 to provide a Response 116 instead of using a Response 116 from LLM engine 108a as a reply 120 to the first user prompt 112.

As described in more detail below, in embodiments prompt processing server 102 performs the selection/arbitration of information resource engines 108 based on corresponding determined intents of user prompts 112.

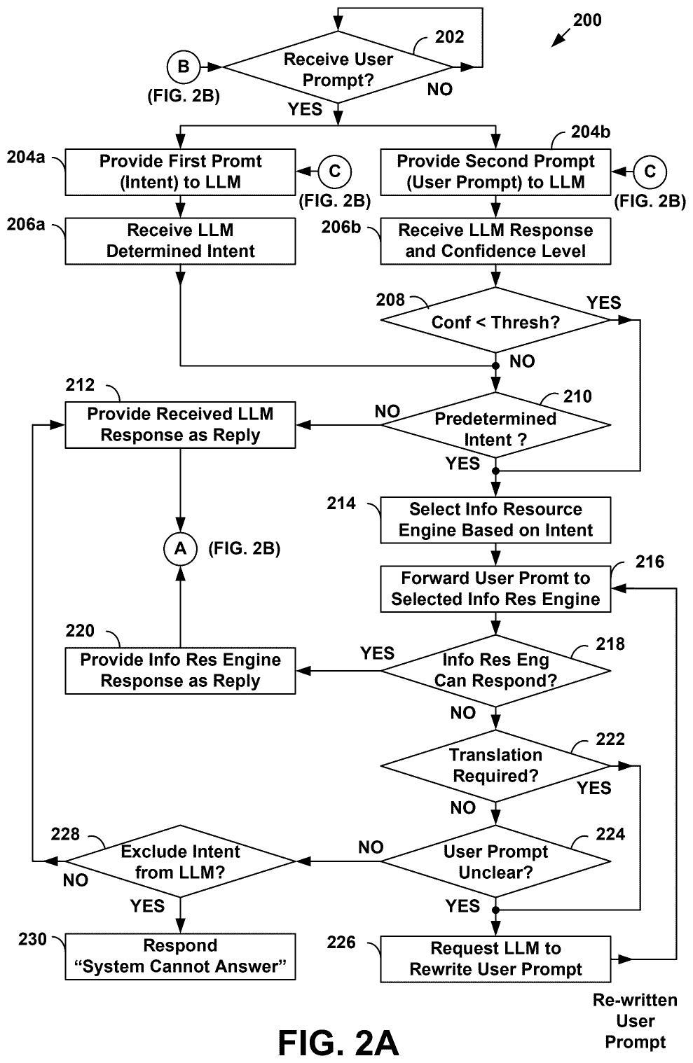

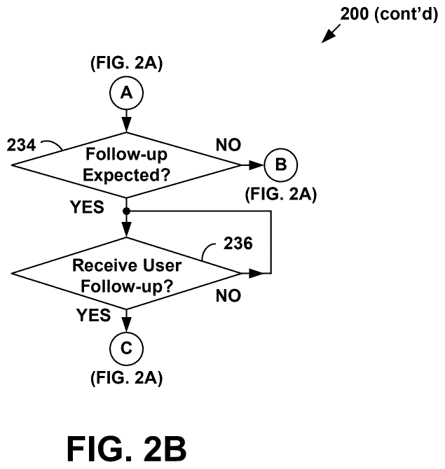

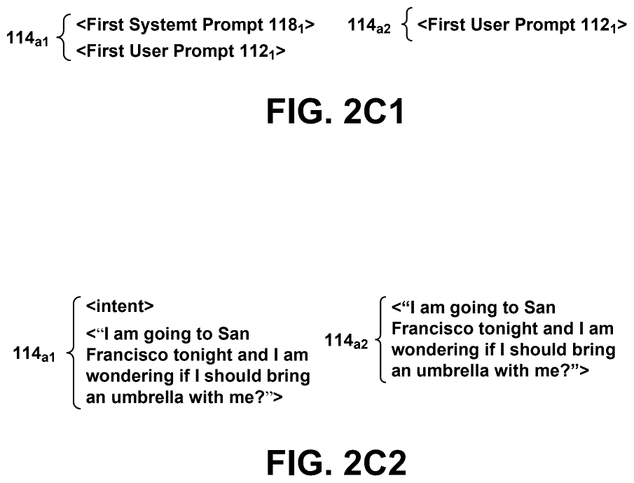

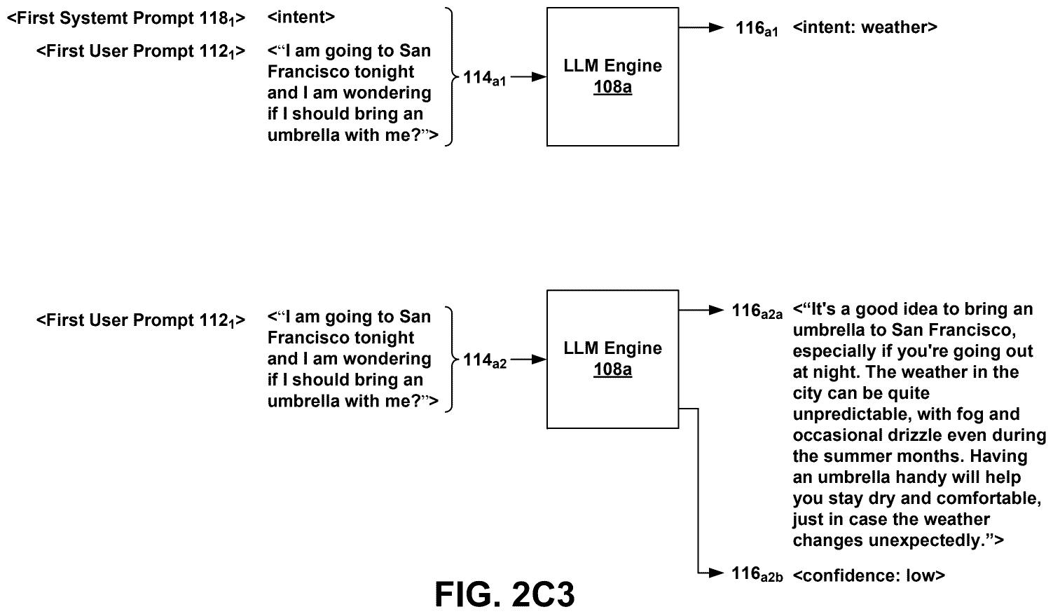

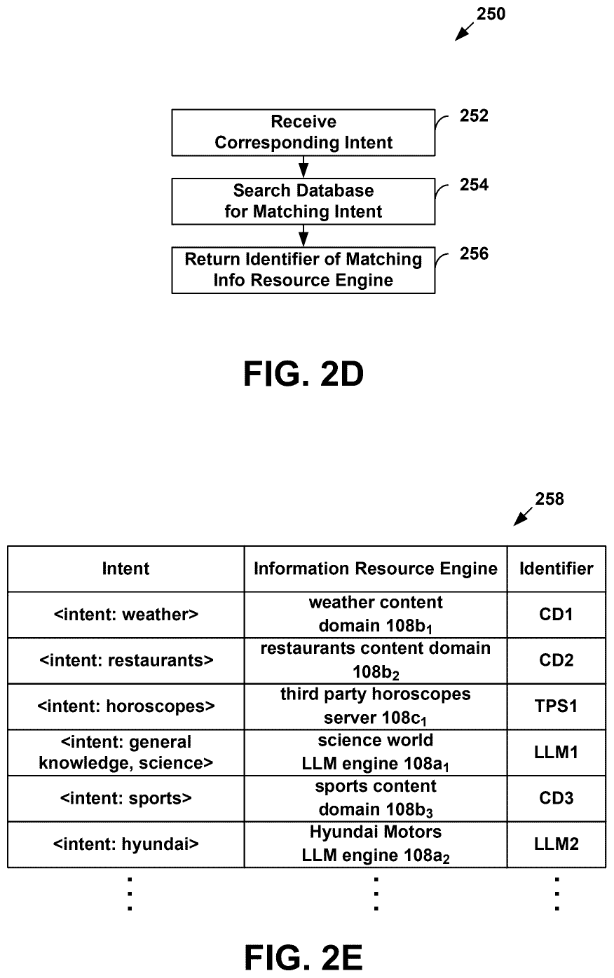

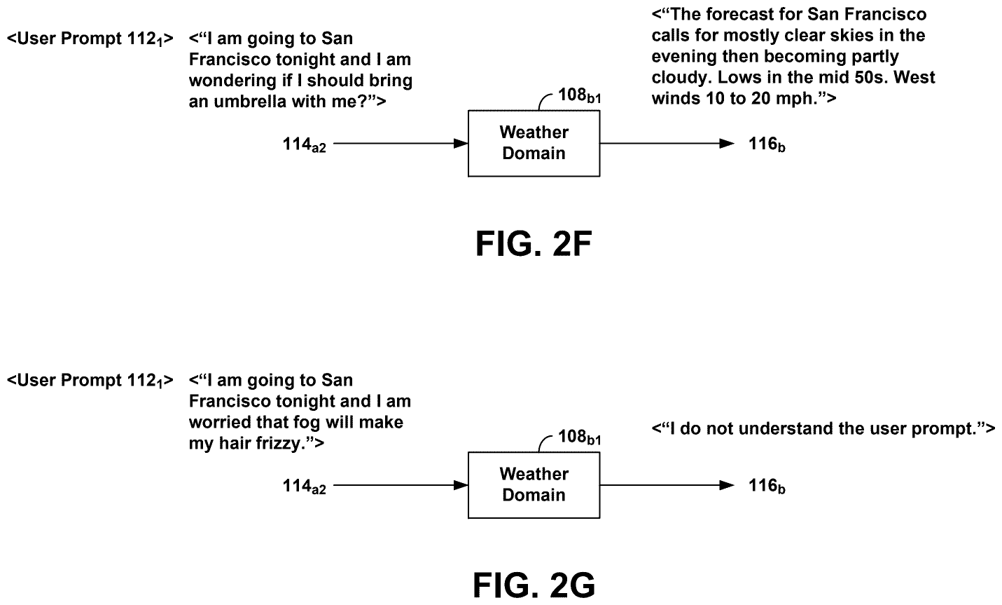

FIGS. 2A-2B include a flowchart showing the operation of an example embodiment of intent-based processing 200 of user prompts 112 by prompt processing server 102 of FIG. 1A. In an embodiment, intent-based processing 200 of user prompts 112 may be performed by the intent-based processing engine 130 of prompt processing server 102 in combination with processor 122.

At step 202, intent-based processing engine 130 determines if a user prompt 112 has been received by prompt processing server 102. If prompt processing server 102 has not received a user prompt 112, intent-based processing engine 130 loops back to step 202 and continues to check for receipt of a user prompt 112.

If at step 202 a determination is made that prompt processing server 102 has received a user prompt 112 (e.g., a first user prompt 112₁), at step 204a intent-based processing engine 130 provides a first LLM prompt 114a₁ to LLM engine 108a, and at step 204b intent-based processing engine 130 provides a second LLM prompt 114a₂ to LLM engine 108a. In embodiments, intent-based processing engine 130 provides first LLM prompt 114a₁ and second LLM prompt 114a₂ to LLM engine 108a substantially at a same time to LLM engine 108a.

FIG. 2C1 depicts an example first LLM prompt 114a₁ that includes a first system prompt 118₁ and first user prompt 112₁, and second LLM prompt 114a₂ that includes first user prompt 112₁. For example, as depicted in FIG. 2C2, first system prompt 118₁ may be <intent> and first user prompt 112₁ may be “I am going to San Francisco tonight and I am wondering if I should bring an umbrella with me?” In an embodiment, first system prompt 118₁ (<intent>) requests that LLM engine 108a determine a corresponding intent for first user prompt 112₁. That is, determine a corresponding intent for first user prompt 112₁ but not actually respond to first user prompt 112₁.

As depicted in FIG. 2C3, in an embodiment LLM engine 108a processes first LLM prompt 114a₁ and generates a first Response 116a₁ that includes the determined corresponding intent of the first user prompt 112₁ (e.g., <intent: weather>).

In addition, in an embodiment LLM engine 108a processes second LLM prompt 114a₂ and generates a second Response 116a₂ₐ that includes the LLM response to the first user prompt 112₁ (e.g., <“It's a good idea to bring an umbrella to San Francisco, especially if you're going out at night. The weather in the city can be quite unpredictable, with fog and occasional drizzle even during the summer months. Having an umbrella handy will help you stay dry and comfortable, just in case the weather changes unexpectedly.”>).

In an embodiment, LLM engine 108a optionally also generates and a third Response 116a_{2b} that includes the LLM's determination of a confidence level associated with second Response 116a₂ₐ (i.e., the LLM response to first user prompt 112₁). In embodiments, example confidence levels may be <confidence: low>, <confidence: medium>, <confidence: high>, or other similar confidence levels. Persons of ordinary skill in the art will understand that LLM engine 108a may provide more or fewer than three confidence levels.

For example, LLM 108a may be trained to assess confidence of the LLM's responses to user prompts 112. In particular, example user prompts 112 regarding particular subjects (e.g., weather) and example LLM responses to such example user prompts 112 (e.g., “I am sorry. I do not have access to real time weather information.”) may be provided to LLM 108a, along with a specified confidence level (e.g., <confidence: low> associated with the example response. By providing multiple such examples, LLM 108a learns how to determine associated confidence levels for the LLM's responses to similar user prompts 112.

In the example of FIG. 2C3, LLM engine 108a generates a third Response 116a_{2b} (e.g., <confidence: low>) indicating that LLM 108a determined an associated confidence (<confidence: low>) in second Response 116a₂ₐ (i.e., the LLM response to the first user prompt 112₁).

Referring again to FIGS. 2A-2B, at step 206a intent-based processing engine 130 receives first Response 116a₁ₐ (e.g., the determined corresponding intent of the first user prompt 112₁) from LLM engine 108a.

At step 206b intent-based processing engine 130 receives second Response 116a₂ₐ (e.g., the LLM response to first user prompt 112₁) and third Response 116a_{2b} (i.e., the confidence level in second Response 116a₂ₐ (the LLM response to the first user prompt 112₁)).

At step 208, intent-based processing engine 130 compares third Response 116a_{2b} (i.e., the confidence level in second Response 116a₂ₐ (the LLM response to the first user prompt 112₁)) with a threshold confidence level. For example, the threshold confidence level may be <confidence: high>.

If at step 208 intent-based processing engine 130 determines that the confidence level in second Response 116a₂ₐ (the LLM response to first user prompt 112₁) is not less than the threshold confidence level, at step 210 intent-based processing engine 130 determines whether the determined corresponding intent of first user prompt 112₁ is a predetermined intent.

In embodiments, if a user prompt 112 (e.g., first user prompt 112₁) has a corresponding intent that is any of one or more predetermined intents, intent-based processing engine 130 selects an information source 108 to process and provide a response 116 to such user prompt 112. In embodiments, predetermined intents may be intents for which one more of content domains 108b and/or third party servers 108c are especially suited. For example, predetermined intents may include weather, sports, stock prices, restaurant reservations, movie times, or other similar predetermined intents. In an embodiment, definitions datastore 128 of FIG. 1A may include a list of predetermined intents.

If at step 210 intent-based processing engine 130 determines that first Response 116a₁ₐ (e.g., the determined corresponding intent of first user prompt 112₁) is not a predetermined intent, then at step 212 intent-based processing engine 130 provides second Response 116a₂ₐ (the LLM response to first user prompt 112₁) as a reply 120 to the end user 110 who provided first user prompt 112₁.

In other words, if the determined corresponding intent of first user prompt 112₁ is not a predetermined intent, and if the LLM's assessed confidence level meets or exceeds the threshold confidence level, intent-based processing engine 130 determines that the LLM response to first user prompt 112₁ should be provided as the reply 120 to the end user 110.

If, however, at step 208 intent-based processing engine 130 determines that the confidence level in second Response 116a₂ₐ (the LLM response to first user prompt 112₁) is less than the threshold confidence level, or at step 210 intent-based processing engine 130 determines that first Response 116a₁ₐ (e.g., the determined corresponding intent of first user prompt 112₁) is a predetermined intent, then at step 214 intent-based processing engine 130 accesses information resource arbitration engine 132 of FIG. 1A.

In an embodiment, at step 214 intent-based processing engine 130 selects, based on the determined first Response 116a₁ₐ (e.g., the determined corresponding intent of first user prompt 112₁), an information resource engine 108 to process and generate a Response 116 to second LLM prompt 114a₂ (e.g., first user prompt 112₁).

In other words, for scenarios in which the determined confidence level in the response of LLM 108a to first user prompt 112₁ is less than the threshold confidence level, or the determined corresponding intent of first user prompt 112₁ is a predetermined intent, intent-based processing engine 130 will select, based on the determined first Response 116a₁ₐ (e.g., the determined corresponding intent of first user prompt 112₁), an information resource engine 108 other than LLM engine 108a to generate a Response 116 to first user prompt 112₁.

FIG. 2D is a flowchart showing the operation of an example embodiment of intent-based selection 250 of information resource engines 108 by prompt processing server 102 of FIG. 1A. In an embodiment, intent-based selection 250 of information resource engines 108 may be performed by information resource arbitration engine 132 of prompt processing server 102 in combination with processor 122.

At step 252, information resource arbitration engine 132 receives determined first Response 116a₁ₐ (e.g., the determined corresponding intent of first user prompt 112₁). At step 254, information resource arbitration engine 132 searches a database of predetermined intents to find any predetermined intents that match the received determined first Response 116a₁ₐ (e.g., the determined corresponding intent of first user prompt 112₁). At step 256, information resource arbitration engine 132 returns information resource identifiers corresponding to the matching predetermined intents identified at step 254.

FIG. 2E is a diagram depicting an example database 258 of predetermined intents, associated information resource engines 108, and corresponding information resource engine identifiers. In the illustrated example, <intent: weather> is associated with weather content domain 108b₁, which has a corresponding information resource engine identifier CD1. Similarly, <intent: restaurants> is associated with restaurants content domain 108b₂, which has a corresponding information resource engine identifier CD2. Likewise, <intent: horoscopes> is associated with third party horoscopes server 108c₁, which has a corresponding information resource engine identifier TPS1, and so on.

As evident in example database 258, some predetermined intents are associated with content domains 108b, some predetermined intents are associated with third party servers 108c, and other predetermined intents are associated with LLM engines 108a. In an embodiment, definitions datastore 128 of FIG. 1A may include database 258 of predetermined intents.

Referring again to FIG. 2A, at step 216 intent-based processing engine 130 forwards second LLM prompt 114a₂ (i.e., first user prompt 112₁) to the information resource engine 108 selected at step 214. For example, if at step 214 information resource arbitration engine 132 selects weather content domain 108b₁, then at step 216 intent-based processing engine 130 forwards second LLM prompt 114a₂ (i.e., first user prompt 112₁) to weather content domain 108b₁ for processing.

Thus, as depicted in FIG. 2F, weather content domain 108b₁ processes second LLM prompt 114a₂ (i.e., first user prompt 112₁) and generates a Response 116b that includes the weather content domain 108b₁ response 116b (e.g., <“The forecast for San Francisco calls for mostly clear skies in the evening then becoming partly cloudy. Lows in the mid 50s. West winds 10 to 20 mph”>).

Referring again to FIG. 2A, at step 218 intent-based processing engine 130 determines whether the information resource engine 108 selected at step 214 was able to process second LLM prompt 114a₂ (i.e., first user prompt 112₁) and generate a Response 116b. In particular, in some instances the selected information resource engine 108 may not understand a user prompt 112. For example, if a selected information resource engine 108 is configured to process English language user prompts, but the user prompt 112 provided to the selected information resource engine 108 is in French, the selected information resource engine 108 may not be able to comprehend and process the user prompt 112.

By way of another example, even though LLM engine 108a may be able to correctly determine a corresponding intent of a user prompt 112, the selected information resource engine 108 may not clearly understand the meaning of the user prompt 112. For example, in FIG. 2G the second LLM prompt 114a₂ (i.e., first user prompt 112₁) provided to the weather content domain 108b₁ is <“I am going to San Francisco tonight and I am worried that fog will make my hair frizzy.”>.

In this example, even though LLM engine 108a may have correctly determined <intent: weather>, the weather content domain 108b₁ may not be able to understand what the user prompt 112 is actually requesting. In this scenario the weather content domain 108b₁ may indicate that the user prompt 112 is unclear (or far-fetched) and cannot be processed.

Referring again to FIG. 2A, if at step 218 intent-based processing engine 130 determines that the selected information resource engine 108 from step 214 was able to process second LLM prompt 114a₂ (i.e., first user prompt 112₁) and generate a Response 116b, then at step 220 intent-based processing engine 130 provides Response 116b as a reply 120 to the end user 110 who provided first user prompt 112₁.

If, however, at step 218 intent-based processing engine 130 determines that that the selected information resource engine 108 from step 214 was unable to process second LLM prompt 114a₂ (i.e., first user prompt 112₁) and generate a Response 116b, then at step 222 intent-based processing engine 130 determines whether second LLM prompt 114a₂ (i.e., first user prompt 112₁) must be translated to a language that the selected information resource engine 108 can understand.

In the example described above, if the weather content domain 108b₁ is configured to process English language user prompts, but second LLM prompt 114a₂ (i.e., first user prompt 112₁) is in French, the first user prompt 112₁ must be translated from French to English before weather content domain 108b₁ can process the user prompt.

If at step 222 intent-based processing engine 130 determines that second LLM prompt 114a₂ (i.e., first user prompt 112₁) must be translated, then at step 226 intent-based processing engine 130 sends LLM 108a a “Prompt Rewrite” request asking LLM 108a to rewrite the first user prompt 112₁ in English. For example, the Prompt Rewrite request may include the following system prompts 118: <rewrite> <language: English>.

In an embodiment, LLM 108a may be configured to process the Prompt Rewrite request and translate second LLM prompt 114a₂ (i.e., first user prompt 112₁) from the original language of first user prompt 112₁ to English. In an embodiment, LLM 108a also may be configured to convert any subsequent Response 116 from the selected information resource engine 108 from English to the original language of first user prompt 112₁.

After LLM 108a processes the Prompt Rewrite request, intent-based processing engine 130 loops back to step 216 and forwards the translated second LLM prompt 114a₂ (i.e., the translated first user prompt 112₁) to the information resource engine 108 selected at step 214.

If however at step 222 intent-based processing engine 130 determines that second LLM prompt 114a₂ (i.e., first user prompt 112₁) does not require translation, then at step 224 intent-based processing engine 130 determines whether the first user prompt 112₁ was unclear. For example, as depicted in FIG. 2G described above, the weather content domain 108b₁ was unable to understand the user prompt 112 and indicated that the user prompt 112 was unclear or far-fetched and cannot be processed.

If at step 224 intent-based processing engine 130 determines that second LLM prompt 114a₂ (i.e., first user prompt 112₁) was unclear, then at step 226 intent based processing engine 130 sends LLM 108a a “Prompt Rewrite” request asking LLM 108a to rewrite the first user prompt 112₁. For example, the Prompt Rewrite request may include the following system prompts 118: <rewrite> <clear>.

In an embodiment, LLM 108a may be configured to process the Prompt Rewrite request and rewrite second LLM prompt 114a₂ (i.e., first user prompt 112₁) to improve the clarity of the user prompt. From the example of FIG. 2G, LLM 108a may rewrite the original user prompt <“I am going to San Francisco tonight and I am worried that fog will make my hair frizzy.”> to <“What is the weather forecast tonight for San Francisco?”>.

After LLM 108a processes the Prompt Rewrite request, intent-based processing engine 130 loops back to step 216 and forwards the rewritten second LLM prompt 114a₂ (i.e., the rewritten first user prompt 112₁) to the selected information resource engine 108 from step 214.

If at step 224 intent-based processing engine 130 determines the first user prompt 112₁ was not unclear, then at step 228 intent-based processing engine 130 determines whether first Response 116a₁ₐ (e.g., the determined corresponding intent of the first user prompt 112₁) from step 206a is an intent for which LLM engine 108a should be excluded from processing (referred to herein as an “exclude intent”).

For example, 102 a service provider operating prompt processing server 102 may provide a list of exclude intents for which LLM engine 108a should never process user prompts 112. In an embodiment, definitions datastore 128 of FIG. 1A may include the list of exclude intents. For example, a list of exclude intents may include: car control, home automation, navigation, prohibited subjects, or other intents for which the service provider determines that LLM engine 108a should never process user prompts 112.

If at step 228 intent-based processing engine 130 determines that first Response 116a₁ₐ (e.g., the determined corresponding intent of the first user prompt 112₁) from step 206a is not an exclude intent, then at step 212 intent-based processing engine 130 provides second Response 116a₂ₐ (the LLM response to the first user prompt 112₁) as a reply 120 to the end user 110 who provided first user prompt 112₁.

In other words, in circumstances in which the selected information resource engine 108 from step 214 is unable to provide a response 116 to first user prompt 112₁, and first Response 116a₁ₐ (e.g., the determined corresponding intent of the first user prompt 112₁) from step 206a is not an exclude intent, intent-based processing engine 130 provides the LLM engine 108a response to the first user prompt 112₁ as a reply 120 to the end user 110 who provided first user prompt 112₁.

If at step 228 intent-based processing engine 130 determines that first Response 116a₁ₐ (e.g., the determined corresponding intent of the first user prompt 112₁) from step 206a is an exclude intent, then at step 230 intent-based processing engine 130 provides a response (e.g., “System Cannot Answer”) as a reply 120 to the end user 110 who provided first user prompt 1121. In this regard, intent-based processing engine 130 determines that no answer is more desirable than a reply from LLM engine 108a.

Referring to FIGS. 2A-2B, after step 212 at which intent-based processing engine 130 provides second Response 116a₂ₐ (the LLM response to first user prompt 112₁) as a reply 120 to the end user 110 who provided first user prompt 112₁, or after step 220 at which intent-based processing engine 130 provides Response 116b as a reply 120 to the end user 110 who provided first user prompt 112₁, at step 234 intent-based processing engine 130 determines if a follow up user prompt 112 is expected from the end user 110 after receiving the reply 120 provided at step 212.

For example, LLM engine 108a may be trained to expect a follow up user prompt after providing certain Responses 116. In such scenarios, in addition to providing a Response 116, LLM engine 108a also may provide a system prompt 118 <Follow Up Expected: Yes> to inform intent-based processing engine 130 to expect a follow-up user prompt. For other Responses 116, in addition to providing a Response 116, LLM engine 108a also may provide a system prompt 118 <Follow Up Expected: No> to inform intent-based processing engine 130 not to expect a follow-up user prompt.

If at step 234 intent-based processing engine 130 determines that a follow up user prompt 112 is not expected from the end user 110, intent-based processing engine 130 loops back to step 202 to determine if another user prompt 112 has been received by prompt processing server 102.

If, however, at step 234 intent-based processing engine 130 determines that a follow up user prompt 112 is expected from the end user 110, at step 236 intent-based processing engine 130 determines if a follow-up user prompt 112 has been received by prompt processing server 102. If at step 236 intent-based processing engine 130 determines that prompt processing server 102 has not received a follow-up user prompt 112, intent-based processing engine 130 loops back to step 236 and continues to check for receipt of a follow-up user prompt 112.

If, however, at step 236 intent-based processing engine 130 determines that prompt processing server 102 has received a follow up user prompt 112 has been received from the end user 110, at step 204a intent-based processing engine 130 provides a third LLM prompt 114a₃ to LLM engine 108a, and at step 204b intent-based processing engine 130 provides a fourth LLM prompt 114a₄ to LLM engine 108a.

In an embodiment, third LLM prompt 114a₃ includes first system prompt 118₁ (<intent>) and the follow-up user prompt received at step 236, and fourth LLM prompt 114a₄ that includes the follow-up user prompt received at step 236. In this regard, the process described above repeats with the received follow-up user prompt. In embodiments, LLM engine 108a retains the prompt history and thus processes the follow-up user prompt with the context of what has already transpired regarding processing of first user prompt 112₁.

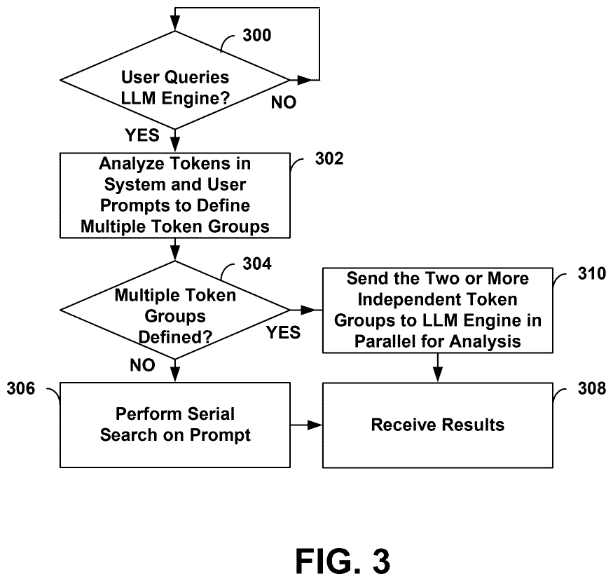

In embodiments, intent-based selection of information resource engines 108 may be facilitated by parallel processing, nested processing and dynamic processing of prompts by LLM engine 108. FIG. 3 is a flowchart showing the operation of a simple embodiment for parallel processing of prompts provided by prompt processing server 102 to LLM engine 108a. Further embodiments relate to nested and dynamic prompts with the possibility of recursive loops. Those embodiments will be explained below. Parallel processing of prompts may be performed by parallel processing engine 134 of prompt processing server 102 in combination with processor 122.

In step 300, parallel processing engine 134 looks for a user prompt 112 for LLM engine 108a. Upon receipt of such a user prompt 112, parallel processing engine 134 analyzes the tokens in the system and user prompts to define multiple token groups in step 302. The criteria that parallel processing engine 134 uses in step 302 is whether one or more of the tokens received in step 300 may be searched independently of each other.

For example, typically system prompts 118 are unrelated to each other and may be searched independently. As for user prompts 112, where two or more tokens are unrelated (for example do not modify each other), the tokens may be searched independently. Parallel processing engine 134 may perform step 302, or alternatively the system prompts 118 and user prompts 112 may be sent to LLM engine 108a for initial analysis, with LLM engine 108a determining which tokens may be searched independently of each other.

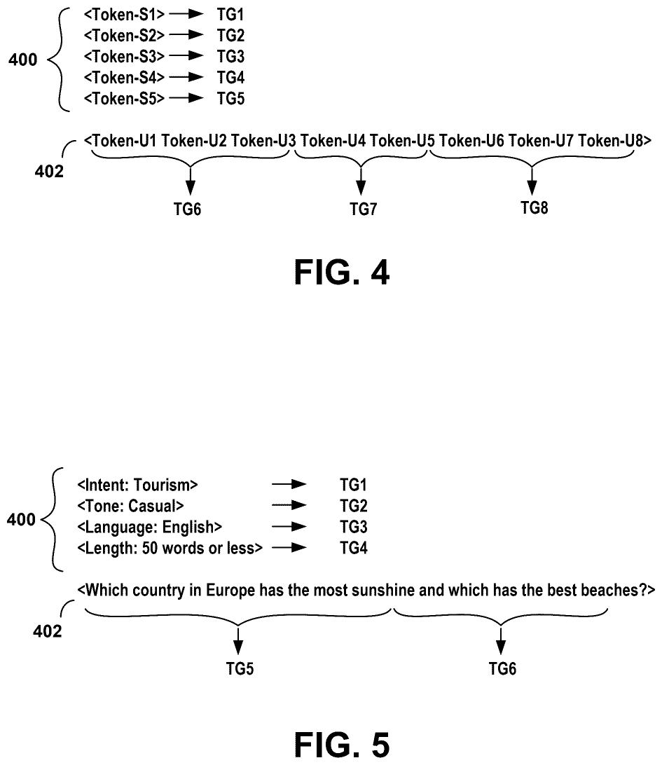

Upon identifying the tokens in the system prompts 118 and/or user prompts 112 which may be searched independently, independent tokens are classified and stored into their own token groups. FIG. 4 illustrates an example of a Prompt 114 that includes system tokens S1-S5 and user tokens U1-U6 from the user query.

In step 302, parallel processing engine 134 (alone or with assistance from LLM engine 108a) has classified the various tokens into eight token groups TG1-TG8. In particular, each system prompt 118 was broken into its own token group, and it was determined that user tokens U1-U3 constitute a token group, tokens U4-U5 constitute a token group and tokens U6-U8 constitute a token group.

Persons of ordinary skill in the art will understand that the number and breakdown of tokens and token groups shown in FIG. 4 is by way of example only for illustrative purposes, and that any number of tokens may be broken down into any number of token groups in further embodiments. For example, a user prompt 112 may include many more tokens, possibly broken down into additional token groups.

FIG. 5 illustrates an actual example where a user has presented a query:

“Which country in Europe has the most sunshine and which has the best beaches?”

In this example, prompt processing server 102 may additionally include system prompts 118 of <Intent: Tourism>, <Tone: Casual>, <Language: English> and <Length: 50 words or less>. Parallel processing engine 134 may parse this query including system prompts 118 and user prompt 112 into six different token groups. Parallel processing engine 134 (by itself or in combination with LLM engine 108a) may determine that each system prompt 118 may be its own token group TG1-TG4. Parallel processing engine 134 (by itself or in combination with LLM engine 108a) may determine that the user prompts 112 can be broken down into two token groups TG5 and TG6. Each of these token groups TG1-TG6 may be searched in parallel by parallel processing engine 134.

The example of FIG. 5 illustrates a further concept of the present technology. In particular, one or more tokens from a token group may be imported into another token group for context. Token group TG5 includes the tokens “which country in Europe has . . . ” Token group TG6 includes the tokens “and which has . . . ” If searched by itself, token group TG6 would not capture the user intent of finding the best beaches specifically in Europe.

Thus, parallel processing engine 134 (by itself or in combination with LLM engine 108a) may import “country in Europe” from token group TG5 into token group TG6 so that the token group TG6 presented to LLM engine 108a is “and which country in Europe has the best beaches?” Likewise, the question mark from token group TG6 may be imported into token group TG5.

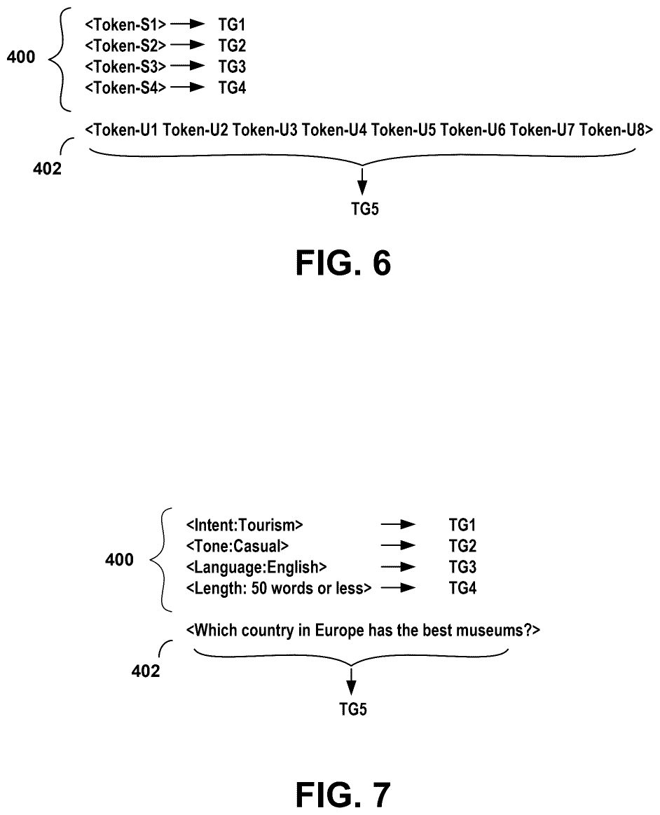

In the embodiment above, the user prompt 112 was parsed into separate token groups. However, it may happen that the user prompt 112 is not easily separated into independent token groups. Thus, in further embodiments illustrated for example in FIG. 6, the tokens of the user prompt 112 may not be separated, but rather taken as a whole as a single token group. Each of the system prompt tokens may still be treated as separate token groups so that the single user prompt token group can be searched in parallel with one or more of the separate system prompt token groups.

FIG. 7 illustrates an actual example where a user has presented a query:

“Which country in Europe has the best museums?”

In this example, prompt processing server 102 may additionally include system prompts 118 of <Intent: Tourism>, <Tone: Casual>, <Language: English> and <Length: 50 words or less> as above. Parallel processing engine 142 may parse this query including the system prompts 118 and user prompt 112 into five different token groups.

Parallel processing engine 142 (by itself or in combination with LLM engine 108a) may determine that each system prompt 400 may be its own token group TG1-TG4. Parallel processing engine 142 (by itself or in combination with LLM engine 108a) may determine that the user prompts 112 cannot be contextually broken down into different token groups and are to be searched as a whole. However, the user token group TG5 may be searched in parallel with token groups TG1-TG4 from the system prompts 118.

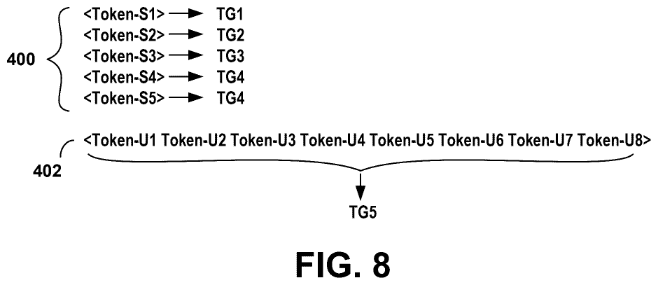

As a further example, it may happen that one or more of the system prompts 118 are contextually dependent on another system prompt 118 or the user prompt 118, and cannot be searched in parallel. This scenario is shown generically in FIG. 8, where system prompts S4 and S5 are dependent on each other (and both are grouped together into token group TG4).

For example, one known system prompt 118 is to receive a confidence value <confidence> on a given response <response>. In this example, <confidence> cannot be obtained until after <response> is received. In this example, <response> and <confidence> may be grouped together in a single token group.

Returning now to the flowchart of FIG. 3, in step 304 parallel processing engine 134 checks whether multiple token groups have been defined. If not, a serial (conventional) search of the system prompts 118 and user prompts 112 are performed in step 306 by LLM engine 108a and the results are received in step 214.

On the other hand, if it is determined in step 304 that multiple token groups have been defined (such as for example as shown in FIG. 4), then at step 310 each token group is sent for analysis to the LLM engine 120 in parallel and the results are received in step 308.

Using parallel processing of individual token groups, parallel processing engine 134 is able to reduce the time it takes to analyze a query and return the results to a fraction of the time needed for a conventional serial search of a Prompt. Because the system determined that the individual token groups were independent of each other, searching of the token groups independently will not affect the result found by LLM engine 108a as compared to a conventional serial search of the Prompt.

In the embodiment described above with respect to the flowchart of FIG. 3, token groups are processed in parallel at the same time from start to finish. Some LLMs may have a token limit, or it may otherwise be desirable to break a query into one or more token groups which are processed with different beginning and ending times, depending on satisfaction of a start and/or end condition.

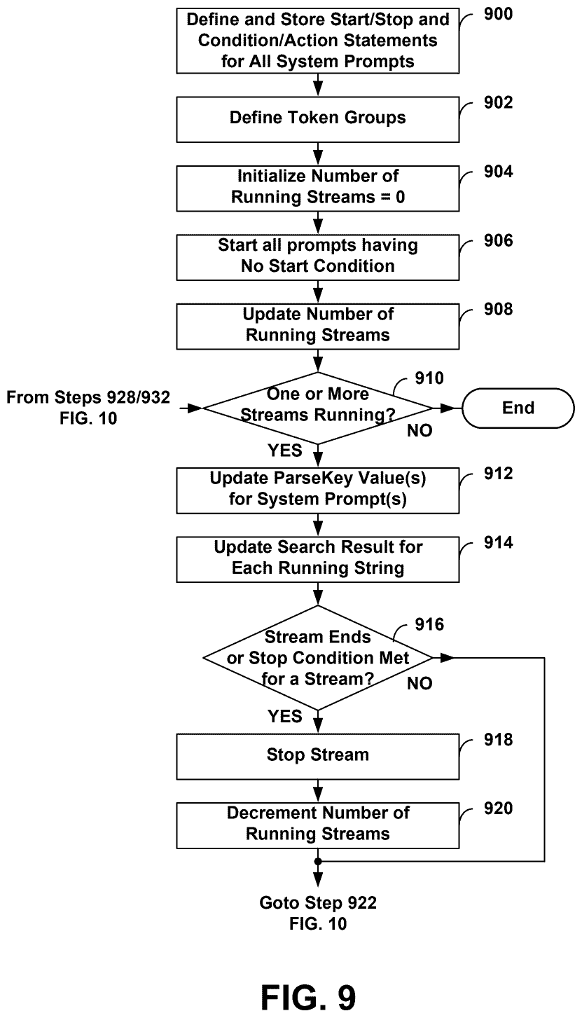

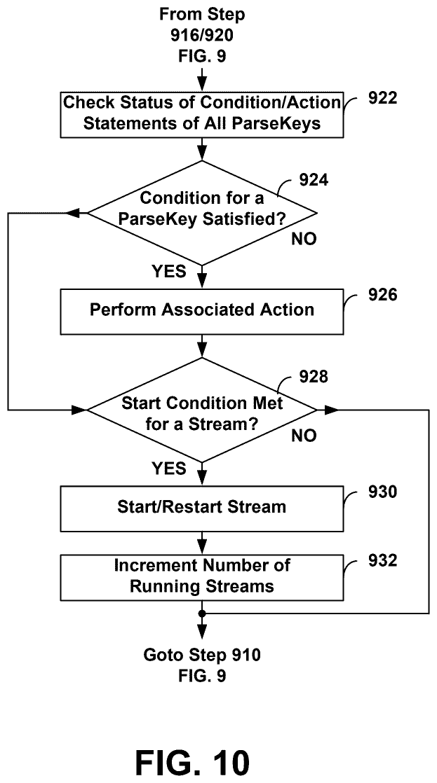

This type of operation is referred to herein as a nested query or Prompt, which will now be described with reference to the flowchart of FIGS. 9-10. Although parallel Prompts can run independently of each other, nested prompts can run conditionally depending on the conditional values of earlier prompts.

In an example, a Prompt might be defined by a large number of token groups, some of them system prompts and some of them user prompts. A first subset of one or more of these token groups might run in parallel at the start (i.e., no starting condition). Depending on the result from LLM engine 108a, a second subset of one or more of the token groups may then run.

That is, a result from the first subset of Prompts triggered a start condition for one or more Prompts of the second subset, which then runs as a new (nested) prompt to LLM engine 108a. Running the second subset of token groups may trigger a third nested search of a third subset of one or more token groups, and so on. These streams of two or more nested searches may continue until the ‘Prompt as a whole has completely run. Below are general steps from an algorithm run by nested processing engine 136 (FIG. 1A) for controlling the operation of nested queries.

```
“DynamicPrompts”: [
{
  “StartCondition”: . . .
  “StopCondition”: . . .
  “Prompt”: {
. . .
}
  “ParseKeys”: [“”,“”, . . .],
  “Actions”: [{
“Condition”: “. . .”,
“Action”: { }
    }, . . .]
},
. . .
]
```

For each token group, nested processing engine 136 continuously runs through the steps of the general algorithm above to start/end initial and nested searches through LLM engine 108a. Depending on results from LLM engine 108a, all of the Prompts may run, or only some of the Prompts may run. For example, if a start condition of a subset of tokens is never satisfied, the query to LLM engine 108a may not be run on that subset of tokens. Additionally, one or more of the Prompts may be run more than once as explained below.

“DynamicPrompts”: [ . . . ]—This is the subroutine which nested prompt engine 136 runs through continuously until all subsets, or streams, of token groups have been processed and results have been returned. Some Prompts (likely system prompts 118 but not necessarily) may include key-value pairs. The key, referred to in the algorithm as a ParseKey, may have an associated tag. This tag may have a constant value. Alternatively, as explained below, the tag may have a variable or dynamic value which may get updated as the algorithm loops.

```
{
  “StartCondition”: . . .
  “StopCondition”: . . .
  “Prompt”: {
. . .
}
```

These lines of the algorithm define a particular Prompt, and any start and/or stop conditions associated with a particular Prompt. The Prompt may be a system prompt 118, a user prompt 112 or a prompt consisting of a token group as discussed above with respect to parallel processing engine 134.

The above lines of the algorithm also define a start and stop condition for a given Prompt. Where no starting condition is defined, the Prompt may automatically run as part of the first subset of Prompts. Where a starting condition is defined, the Prompt will run upon satisfaction of the starting condition and will not run if the starting condition is not satisfied. Normally, once a Prompt begins to run, it will run to its completion. However, where a stop condition is defined, a Prompt may stop running before its completion upon satisfaction of the stop condition.

```
“ParseKeys”: [“”,“”, . . .],
  “Actions”: [{
“Condition”: “. . .”,
“Action”: { }
  }, . . .]
```

This portion of the algorithm defines one or more condition/action statements for parsekeys within a prompt. The condition is defined, as well as the action to be taken upon satisfaction of the parsekey condition. As values get populated, these condition/action statements can trigger various actions, including triggering one or more additional Prompts to be run.

FIGS. 9-10 comprise a single flowchart spread over two figures showing the operation of nested loop engine 136 to run nested Prompts, using for example the above-identified algorithm as a framework. In step 900, nested loop engine 136 may store any predefined start/stop conditions for system prompts 118 and/or any Condition/Action statements for system prompts 118. These conditions and statements may be stored in the prompt definition datastore 128 (FIG. 1A).

In step 902, the system prompts 118 and user prompt 112 may be divided into token groups, also referred to herein as streams. Step 902 may use any of the methods described above with respect to FIG. 3 for parsing the system prompts 118 and user prompts 112 into token groups. Each of these token groups may be run independently as nested streams as explained below.

In step 904, a counter in memory for keeping track of the number of running streams is initialized to 0. In step 906, any of the streams defined in step 902 which have no start condition may run in parallel. These streams may be sent to LLM engine 108a for processing in parallel as explained above with respect to FIG. 3. In step 908, the counter for the number of running streams is updated.

In step 910, nested loop engine 136 checks the counter to see if any streams are running. If not, this means that processing of all streams has completed and the flow ends. On the other hand, assuming the counter shows one or more streams running in step 910, at step 912 the values of any ParseKey prompts are updated.

In particular, the tags associated with ParseKeys may be constant, or they may be dynamic (variable). As one easy example, a ParseKey may exist as <Confirming Query>. This ParseKey in effect causes LLM engine 108a to present an introductory response merely confirming the user input query. So in response to one of the above example queries:

“which country in Europe has the best museums?”

LLM engine 108a may provide an initial confirmation based on the <Confirming Query> ParseKey:

“Certainly, here's a response to the query ‘which country in Europe has the best museums?’”

In this example, the tag or argument for the ParseKey <Confirming Query> is dynamic and will change depending on the user prompt 112. There are a many other examples where the tag associated with a given ParseKey may be dynamic. In step 912 the current state of the tags for ParseKeys are checked and, if conditions have changed since the last check, the state is updated.

In step 914, the search results for all running streams are updated, using the current state of all ParseKeys. This update may comprise sending the streams then running to LLM engine 108a for analysis, or this update may comprise sending only the updated streams (those having updated ParseKeys) to LLM engine 108a for analysis.

In step 915, nested loop engine 136 checks whether a stream has naturally run to its completion, or a defined stop condition has been met for one or more of the streams then running. If so, those one or more streams are stopped in step 918. In step 920, the counter is decremented by the number of streams which were stopped in step 918.

If no streams ended in step 916, or if streams ended and steps 918 and 920 were performed, nested loop engine 136 then proceeds to step 922 in FIG. 10. In step 922, nested loop engine 136 checks the status of any Condition/Action statements from ParseKeys with active streams.

As noted above, ParseKeys may define some action to be performed upon satisfaction of some condition. As one simple example, a ParseKey may trigger the start of a new stream upon satisfaction of the defined condition. As another example, a <Language> ParseKey may be defined which states that where an input query is received in a language other than English, the Response from LLM engine 108a is provided in the received language.

As a further action, if a condition is satisfied, a ParseKey may set an action to run an API accessing a third-party server 108c (FIG. 1A) instead of or in addition to LLM engine 108a. A wide variety of Condition/Action statements may be checked in step 922. In step 924, where a condition in a ParseKey for an action to be performed is satisfied, the action is performed in step 926. Where no conditions for running streams are satisfied in step 924, step 926 is skipped.

In step 928, nested loop engine 136 checks whether a changed condition has triggered the start of a new stream. If so, the new stream is started in step 930, and the counter is incremented in step 932.

In a further aspect of the present technology, nested loops may be performed recursively. That is, a first stream may trigger a second stream and then end. The second stream may in turn trigger the first stream to restart. Thus, steps 924 and 928 do not just check for trigger events of streams that have not yet run. Nested loop engine 136 also checks streams that have already run.

If the condition is satisfied for a loop to recursively run again, that loop is restarted in step 930 and the number of streams in incremented in step 932. If no start condition was triggered in step 928, or a new stream was started in steps 930 and 932, the flow returns to step 910 (FIG. 9) to run through the loop again.

As an example of the recursive feature of the present technology, a user prompt 112 can generate Subtask1 which can either generate a final result or a Subtask2. If Subtask1 generates the final result, the final result is sent to the user and the nested prompts end. If Subtask2 is generated, Subtask2 can send an update to the user and dynamically modify the prompt to generate the next result, which can be the final result or a new Subtask3, and this can continue until either the final result is reached or a maximum number of iterations is reached.

Persons of ordinary skill in the art will understand that the above flowcharts for showing the operation of parallel processing engine 134 (FIG. 3) and nested loop engine 136 (FIG. 9-10) are by way of example only. Certain steps may be performed in different orders or omitted entirely, and other steps are possible.

The following is an implementation example of nested loop engine 136. In this example, using a client device 106 (FIG. 1A) an end user 110 inputs a user prompt 112 to prompt process server 102, for example verbally:

“Tell me if it is going to rain in San Francisco at 9 pm and show me Italian restaurants there that are open then.”

Running through the steps of the flowchart of FIGS. 9-10, in a first step, the Dynamic Prompt algorithm shown above runs a first system prompt (e.g., <intent>) to determine the corresponding intent and receives an array “<Intent: Weather, Restaurant Search>”. A <Confirming Query> ParseKey may also be used to generate a confirmation of the user prompt 112.

For each intent, nested loop engine 136 then runs a separate prompt in parallel (no start condition). For the weather stream, nested loop engine 136 runs a weather-specific system prompt to generate the weather-specific key-value pairs:

<Location: San Francisco>
<Date: today>
<Time: 9 PM>
<Attribute: rain>

For the restaurant stream, nested loop engine 136 runs another Prompt in parallel to collect other key-value pairs:

<Location: San Francisco>
<Open: 9pm>
<Cuisine: Italian>

Each Prompt above will have an Action that gets triggered based on some conditions. The service provider of prompt processing server 102 is aware that for current events, such as weather conditions, the LLM model does not have information.

Prompt processing server 102 may implement a further dynamic ParseKey to determine a corresponding intent for the user prompt 112. Based on the determined intent, nested loop engine 136 may identify both streams as asking for predetermined intents for which LLM engine 108a is not trained.

Therefore, for weather, if Location, Date, Time, Attribute are present, the Action to perform is to run an API which accesses a content domain 108b (e.g., weather content domain 108b₁) (or a third party server 108c), which includes current weather data. In embodiments, weather content domain 108b₁ may then return a Response 116b as a reply 120 to the weather related user prompt 112 to end user 110.

Similarly, for restaurants, once nested loop engine 136 has the requisite attributes to satisfy the predefined condition, the Action to perform is to run another API which accesses a content domain 108b (e.g., restaurants content domain 108b₂) (or a third party server 108c), which includes current restaurant data. In embodiments, restaurants content domain 108b₂ may then return a Response 116b as a reply 120 to the restaurant-related user prompt 112 to end user 110. Thus, in the final step, nested loop engine 110 may return a reply 120:

“You asked if it is going to rain in San Francisco at 9 PM and to show Italian restaurants there that are open then. The chance of rain in San Francisco at 9 PM today is 80%. At 9 PM, there are several Italian restaurants that are open, including [restaurant names].”

In embodiments, the results from the various streams from any of the above-identified embodiments may be collected by prompt processing server 102 and presented to end user 110 all at once, and actions on parse keys can be taken upon completion of processing on a given prompt.

However, in accordance with further aspects of the present technologies, all results may be streamed in real time. As the results from one stream or another become available, the results may be streamed to the user, and actions can be taken on parse keys before completion of processing of a prompt as a whole.

For example, as described above, nested loop engine 136 can start processing a second or subsequent stream upon satisfaction of a start condition in an earlier stream. Using the flow as described in FIG. 9-10, key-value pairs can be parsed out of the response in real time, and if other nested prompts depend on some of these key values pairs, they can start generating and streaming their results as soon as their conditions are met.

For example, if PromptA generates <Key1> and <Key2> in sequence, and PromptB needs to wait for <Key1> before it starts, then nested loop engine 136 can start PromptB as soon as <Key1> is available, and it does not need to wait for the entire response of PromptA to finish.

Stop conditions for streams are also discussed above. Nested loop engine 136 can stop the response generation of a certain prompt before finishing on its own based on the key value pairs that are parsed from the current and other prompts. For example, if PromptA generates <Key1> and <Key2>, and PromptB generates <Key3> and <Key4>, and PromptB starts after <Key1> is available, but <Key2> and <Key4> are not necessary based on certain values of <Key1> and <Key3>, nested loop engine 136 can stop both PromptA and PromptB before they finish generating if those conditions on <Key1> and <Key3> are met.

Results can also be streamed to client devices 106 as soon as the results are available. Prompt processing server 102 has the ability to send updated results to client devices 106. For complex tasks that can take tens of seconds, if an end user 110 has to wait tens of seconds for the final response, the user experience is degraded. However, if real time progress updates are provided more frequently, e.g., every few seconds, the user experience for the response is improved. As an example:
User: complete TaskA
Response 1: Got it! Let me work on completing TaskA
Response 2: I found SubTastk1 and Subtask2. Checking on both.
Response 3: Subtask1 result is . . .
Response4: Subtask2 result is . . .
Response5: Now putting it together
Response6: The final result of TaskA is . . .

Parallel processing engine 134 and nested loop engine 136 have been described above as two separate engines or application programs. However, persons of ordinary skill in the art will understand that parallel processing engine 134 and nested loop engine 136 may be integrated together as part of a single engine or application program.

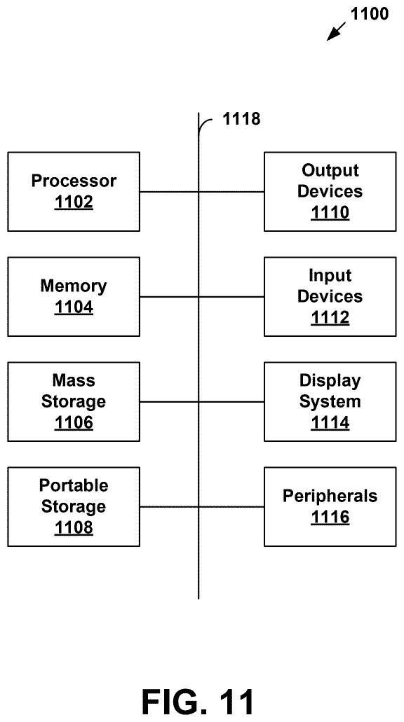

FIG. 11 illustrates an exemplary computing system 1100 that may be prompt processing server 102 used to implement an embodiment of the present technology. Computing system 1100 includes one or more processors 1102 and main memory 1104. Main memory 1104 stores, in part, instructions and data for execution by processor 1102.

Main memory 1104 can store the executable code when computing system 1100 is in operation. Computing system 1100 may further include a mass storage device 1106, portable storage medium drive(s) 1108, output devices 110, user input devices 1112, a display system 1114, and other peripheral devices 1116.

The components shown in FIG. 11 are depicted as being connected via a single bus 1118. The components may be connected through one or more data transport means. Processor 1102 and main memory 1104 may be connected via a local microprocessor bus, and mass storage device 1106, portable storage medium drive(s) 1108, display system 1114, and peripheral device(s) 1116 may be connected via one or more input/output (I/O) buses.

Mass storage device 1106, which may be implemented with a magnetic disk drive or an optical disk drive, is a non-volatile storage device for storing data and instructions for use by processor 1102. Mass storage device 1106 can store the system software for implementing embodiments of the disclosed technology for purposes of loading that software into main memory 1104.

Portable storage medium drive(s) 1108 operate in conjunction with a portable non-volatile storage medium, such as a floppy disk, compact disk or digital video disc, to input and output data and code to and from computing system 1100. The system software for implementing embodiments of the disclosed technology may be stored on such a portable medium and input to computing system 1100 via portable storage medium drive(s) 1108.

Input devices 1112 provide a portion of a user interface. Input devices 1112 may include an alpha-numeric keypad, such as a keyboard, for inputting alpha-numeric and other information, or a pointing device, such as a mouse, a trackball, stylus, or cursor direction keys. Additionally, computing system 1100 as includes output devices 1110. Suitable output devices include speakers, printers, network interfaces, and monitors. Where computing system 1100 is part of a mechanical client device, output devices 1110 may further include servo controls for motors within the mechanical device.

Display system 1114 may include a liquid crystal display (LCD) or other suitable display device. Display system 1114 receives textual and graphical information, and processes the information for output to the display device.

Peripheral device(s) 1116 may include any type of computer support device to add additional functionality to the computing system. Peripheral device(s) 1116 may include a modem or a router.

The components contained in computing system 1100 are those typically found in computing systems that may be suitable for use with embodiments of the disclosed technology and are intended to represent a broad category of such computer components that are well known in the art.

Thus, computing system 1100 can be a personal computer, hand held computing device, telephone, mobile computing device, workstation, server, minicomputer, mainframe computer, or any other computing device. The computer also can include different bus configurations, networked platforms, multi-processor platforms, etc. Various operating systems can be used including UNIX, Linux, Windows, Macintosh OS, Palm OS, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the disclosed technology. Those skilled in the art are familiar with instructions, processor(s), and storage media.

It is noteworthy that any hardware platform suitable for performing the processing described herein is suitable for use with the disclosed technology. The terms “computer-readable storage medium” and “computer-readable storage media” as used herein refer to any medium or media that participate in providing instructions to a CPU for execution.

Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications

Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or cartridge, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

In summary, one embodiment of the present technology relates to a system for processing prompts to an LLM, the system including an intent-based processing engine configured to determine a corresponding intent of a received prompt, and an information resource arbitration engine configured to select, based on the determined corresponding intent, from a plurality of information resource engines to process the received prompt.

In another example, the present technology relates to a system for processing prompts to an LLM, the system including a memory for storing software code, and one or more processors that are configured to execute the software code to receive a prompt, provide the prompt to an LLM engine, receive from the LLM engine an LLM response to the prompt and a determined confidence level associated with the LLM response, compare the determined confidence level to a confidence level threshold, and select, based on the comparison result, from a plurality of information resource engines to process and provide a response to the prompt.

In a further example, the present technology relates to a method of processing prompts to a large language model. The method includes receiving a prompt, sending the prompt to an LLM engine to determine a corresponding intent of the prompt, receiving the determined intent from the LLM engine, selecting based on the determined intent an information resource engine other than the LLM engine that is better able to process the prompt than the LLM engine, sending the prompt to the selected information resource engine to process and provide a response to the prompt.

The above description is illustrative and not restrictive. Many variations of the disclosed technology will become apparent to those of skill in the art upon review of this disclosure. The scope of the disclosed technology should, therefore, be determined not with reference to the above description, but instead should be determined with reference to the appended claims along with their full scope of equivalents.

Although the disclosed technology has been described in connection with a series of embodiments, these descriptions are not intended to limit the scope of the invention to the particular forms set forth herein. Persons of ordinary skill in the art will understand that the methods of the disclosed technology are not necessarily limited to the discrete steps or the order of the steps described. To the contrary, the present descriptions are intended to cover such alternatives, modifications, and equivalents as may be included within the spirit and scope of the disclosed technology as defined by the appended claims and otherwise appreciated by one of ordinary skill in the art.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, persons of ordinary skill in the art may appreciate that the Internet service may be coupled to one or more databases, repositories, servers, and the like, which may be utilized to implement any of the embodiments of the as described herein.

1. A system for processing prompts to a large language model (LLM), the system comprising:
an intent-based processing engine configured to determine a corresponding intent of a received prompt; and
an information resource arbitration engine configured to select, based on the determined corresponding intent, from a plurality of information resource engines to process the received prompt.

2. The system of claim 1, wherein the intent-based processing engine and the information resource arbitration are integrated together in a single application program.

3. The system of claim 1, wherein the information resource engines comprise one or more of an LLM engine, a content domain, and a third party server.

4. The system of claim 1, wherein:
the information resource engines comprise a plurality of content domains;
each content domain is configured to provide information regarding a corresponding subject matter; and
the information resource arbitration engine is configured to select for processing the received prompt a content domain whose corresponding subject matter matches the determined corresponding intent.

5. The system of claim 1, wherein:
the information resource engines comprise a plurality of third party servers;
each third party server is configured to provide information regarding a corresponding subject matter; and
the information resource arbitration engine is configured to select for processing the received prompt a third party server whose corresponding subject matter matches the determined corresponding intent.

6. The system of claim 1, wherein:
the intent-based processing engine is further configured to provide the received prompt to an LLM engine; and
the LLM engine is configured to determine the corresponding intent of the received prompt.

7. The system of claim 1, wherein:
the intent-based processing engine is further configured to provide the received prompt to an LLM engine; and
the LLM engine is configured to provide the intent-based processing engine with an LLM response to the received prompt.

8. The system of claim 7, wherein the intent-based processing engine is further configured to:
determine that the determined corresponding intent is not one of a plurality of predetermined intents; and
provide the LLM engine response as a reply to the received prompt.

9. The system of claim 7, wherein the intent-based processing engine is further configured to:
determine that the determined corresponding intent is an exclude intent; and
prevent the LLM engine response from being provided as a reply to the received prompt.

10. The system of claim 1, wherein:
the information resource engines comprise a plurality of LLM engines; and
the information resource arbitration engine is configured to select, based on the determined corresponding intent, one of the plurality of LLM engines to process the received prompt.

11. The system of claim 1, wherein:
the received prompt comprises a user prompt; and
the intent-based processing engine is further configured to combine the user prompt with a system prompt that instructs an LLM engine to determine the corresponding intent of the user prompt.

12. A system for processing prompts to a large language model (LLM), the system comprising:
a memory for storing software code; and
one or more processors configured to execute the software code to:
receive a prompt;
provide the prompt to an LLM engine;
receive from the LLM engine an LLM response to the prompt and a determined confidence level associated with the LLM response;
compare the determined confidence level to a confidence level threshold; and
select, based on the comparison result, from a plurality of information resource engines to process and provide a response to the prompt.

13. The system of claim 12, wherein the processor is further configured to:
receive from the LLM engine a corresponding intent of the received prompt; and
select, based on the corresponding intent, from the plurality of information resource engines to process and provide a response to the prompt.

14. The system of claim 12, wherein the processor is further configured to:
determine that the selected information resource engine is unable to process and provide a response to the prompt;
provide the prompt to the LLM engine to rewrite the prompt; and
provide the rewritten prompt to the selected information resource engine to process and provide a response to the rewritten prompt.

15. The system of claim 14, wherein the processor is further configured to repeatedly ask the LLM engine to rewrite the prompt until the selected information resource engine is able to process and provide a response to the prompt.

16. The system of claim 12, wherein the processor is further configured to:
determine that the prompt is in a first language different from a second language used by the selected information resource engine;
provide the prompt to the LLM engine to translate the prompt from the first language to the second language; and
provide the translated prompt to the selected information resource engine to process and provide a response to the translated prompt.

17. The system of claim 16, wherein:
the selected information resource engine provides the response in the selected language; and
the processor is further configured to provide the response to the LLM engine to translate the response from the second language to the first language.

18. The system of claim 12, wherein the processor is further configured to:
determine that the selected information resource engine is unable to process and provide a response to the prompt;
determine that a corresponding intent of the prompt is an exclude intent; and
prevent the LLM engine from responding to the prompt.

19. A method of processing prompts to a large language model (LLM), the method comprising:
receiving a prompt;
sending the prompt to an LLM engine to determine a corresponding intent of the prompt;
receiving the determined intent from the LLM engine;
selecting based on the determined intent an information resource engine other than the LLM engine that is better able to process the prompt than the LLM engine;
sending the prompt to the selected information resource engine to process and provide a response to the prompt.

20. The method of claim 19, wherein:
the prompt comprises a plurality of corresponding intents; and
the method further comprises:
receiving the plurality of determined intents from the LLM engine;
selecting based on the determined intents a plurality of information resource engines other than the LLM engine to process the prompt; and
sending the prompt to the plurality of selected information resource engines to process and provide responses to the prompt.
